(19) United States
(12) Patent Application Publication
(10) Pub. No.: US 2016/0237942 A1
(43) Pub. Date: Aug. 18, 2016

(54) FUEL CONTROL SYSTEM

(71) Applicant: Caterpillar Inc., Peoria, IL (US)

(72) Inventors: Scott Byron Fiveland, Germantown Hills, IL (US); Andrew Loetz, West Lafayette, IN (US); Michael Flory, Bellingham, WA (US); Joel Hiltner, Bellingham, WA (US)

(73) Assignee: Caterpillar Inc., Peoria, IL (US)

(21) Appl. No.: 15/137,229

(22) Filed: Apr. 25, 2016

(51) Int. Cl. F02D 41/26; F02D 41/14

(52) U.S. Cl. CPC F02D 41/263; F02D 41/1441; F02D 41/1448; F02D 41/1454; F02D 41/146

(57) ABSTRACT

A fuel control system for an engine is provided. The fuel control system includes a first sensor configured to generate a signal indicative of a pressure within a cylinder of the engine, a second sensor configured to generate a signal indicative of an amount of Nitrous Oxide (NOx), a fuel reformer, an Air Fuel Ratio (AFR) unit, and a controller. The controller is configured to receive the signals indicative of the pressure and the amount of NOx. The controller is configured to determine a Coefficient of Variation (COV) of Indicated Mean Effective Pressure (IMEP) and compare the COV of IMEP and the amount of NOx with a threshold combustion stability and a threshold amount of NOx respectively. The controller is further configured to regulate at least one of the fuel reformer and the AFR unit to control at least one of the combustion stability and the amount of NOx.

### TECHNICAL FIELD

The present disclosure relates to a fuel control system. More particularly, the present disclosure relates to the fuel control system for an engine.

### BACKGROUND

Engines running on lean air fuel mixtures need to maintain a balance between power output, combustion stability, Nitrous Oxide (NOx) emission, and so on in order to maintain smooth and efficient operation of the engine. Current systems used to maintain the balance employ strategies to control cylinder pressure, fuel injection timing, amount of the fuel injected, Air Fuel Ratio (AFR) of the injected fuel, reforming of the fuel during combustion process, and so on. In some systems, the engines running on the lean air fuel mixture may use hydrogen, produced by an external reformer, to control the combustion stability and/or the NOx emission by controlling the lean mixture combustion.

U.S. Pat. No. 8,099,230 describes an apparatus for controlling an amount of fuel reforming in an internal combustion engine. The engine is configured to selectively operate in a homogeneous charge compression-ignition combustion mode with an exhaust recompression strategy. The apparatus includes a sensor configured to monitor in-cylinder pressures within the engine in real-time. The apparatus also includes a control module. The control module monitors the in-cylinder pressures during a current combustion cycle. The control module also utilizes the monitored in-cylinder pressures to project reforming required in a next combustion cycle. The control module further includes controlling the next combustion cycle based on the projected reforming required in the next combustion cycle. The monitoring of the in-cylinder pressures includes determining a pressure ratio through a recompression period.

However, the current systems include complex strategies to control reforming of the fuel to maintain the combustion stability, the NOx emissions, and so on. Hence, there is a need for an improved fuel control system for reforming of the fuel.

### SUMMARY OF THE DISCLOSURE

In an aspect of the present disclosure, a fuel control system for an engine is provided. The fuel control system includes a first sensor coupled to the engine. The first sensor is configured to generate a signal indicative of a pressure within a cylinder of the engine. The fuel control system includes a second sensor coupled to the engine. The second sensor is configured to generate a signal indicative of an amount of Nitrous Oxide (NOx) present within an exhaust gas of the engine. The fuel control system includes a fuel reformer coupled to the engine. The fuel reformer is adapted to reform a portion of a fuel supplied to the engine into hydrogen (H2) and Carbon Monoxide (CO). The fuel control system also includes an Air Fuel Ratio (AFR) unit coupled to the engine. The AFR unit is adapted to control an air fuel ratio of a mixture of air and the fuel supplied to the engine. The fuel control system further includes a controller coupled to the first sensor, the second sensor, the fuel reformer, and the AFR unit. The controller is configured to receive the signal indicative of the pressure within the cylinder of the engine. The controller is configured to determine a Coefficient of Variation (COV) of Indicated Mean Effective Pressure (IMEP) associated with the engine based on the received signal indicative of the pressure within the cylinder of the engine. The controller is configured to receive the signal indicative of the amount of NOx. The controller is also configured to compare the COV of IMEP and the amount of NOx with a threshold combustion stability and a threshold amount of NOx respectively. The controller is further configured to regulate, based on the comparison, at least one of the fuel reformer and the AFR unit to control at least one of the combustion stability and the amount of NOx.

Other features and aspects of this disclosure will be apparent from the following description and the accompanying drawings.

### BRIEF DESCRIPTION OF THE DRAWINGS

FIG. 1 is a perspective view of an exemplary engine, according to one embodiment of the present disclosure;

FIG. 2 is a block diagram of a fuel control system of the engine of FIG. 1, according to one embodiment of the present disclosure; and

FIG. 3 is a flowchart illustrating a method of working of the fuel control system of FIG. 2, according to one embodiment of the present disclosure.

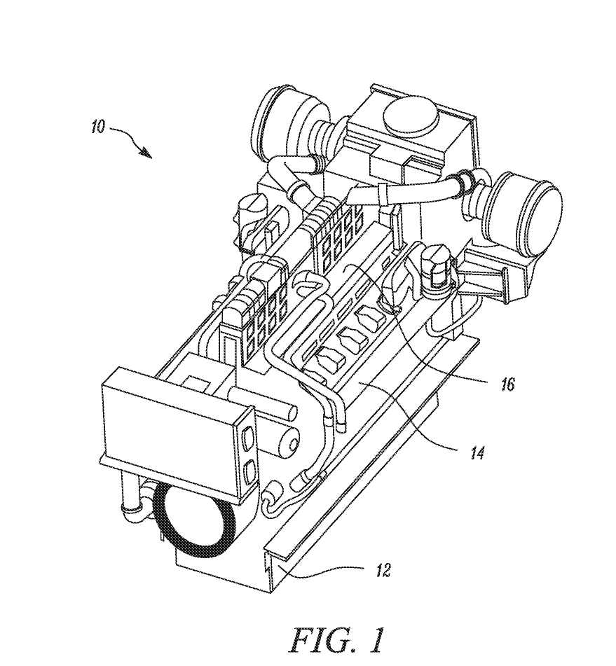

### DETAILED DESCRIPTION

Wherever possible, the same reference numbers will be used throughout the drawings to refer to the same or the like parts. Referring to FIG. 1, a perspective view of an exemplary engine 10 is illustrated. The engine 10 is an internal combustion engine powered by a fuel such as natural gas. The engine 10 may be used for applications including, but not limited to, power generation, transportation, construction, agriculture, forestry, aviation, marine, material handling, and waste management.

The engine 10 includes a frame 12. The frame 12 is configured to support various components of the engine 10 such as an engine block 14 and a cylinder head 16. The frame 12 is also configured to support various components of the engine 10 (not shown) such as a crankcase, a fuel delivery system, an air system, a cooling system, peripheries, a turbocharger, an exhaust gas recirculation system, an exhaust aftertreatment system, and so on. Also, the engine 10 may be of any size including a number of cylinders arranged in any configuration such as inline, radial, “V”, and so on.

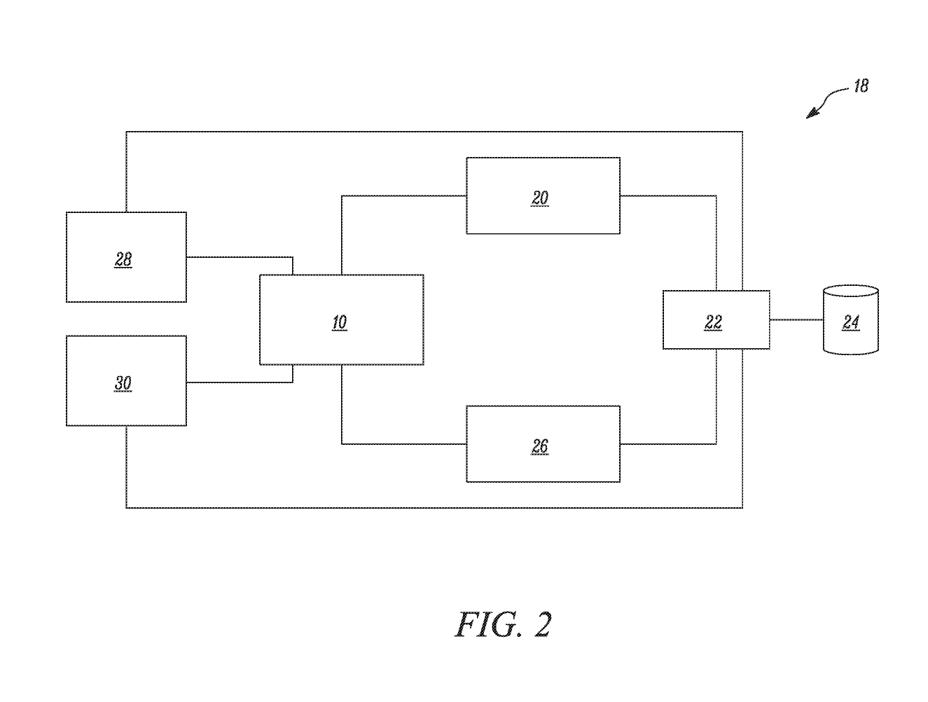

Referring to FIG. 2, a schematic representation of a fuel control system 18 of the engine 10 is illustrated. The fuel control system 18 includes a first sensor 20 coupled. to the engine 10. More specifically, the first sensor 20 is a pressure sensor associated with the cylinder of the engine 10. The first sensor 20 is configured to generate a signal indicative of a pressure within the cylinder such as during a compression stroke. The first sensor 20 is further coupled to a controller 22 of the fuel control system 18. The controller 22 is configured to receive the signal indicative of the pressure within the cylinder from the first sensor 20. Based on the received signal, the controller 22 is configured to determine a Coefficient of Variation (COV) of indicated Mean Effective Pressure (IMEP) associated with the engine 10. The COV of IMEP is indicative of cycle to cycle combustion stability.

In one embodiment, the controller 22 may determine the COV of IMEP based on a correlation stored in a memory (not shown) of the controller 22 or a database 24 coupled to the controller 22. The correlation may be a mathematical expression to determine the COV of IMEP based on values of the pressure within the cylinder and time. In another embodiment, the COV of IMEP may be determined based on a dataset stored. in the database 24. The dataset may include values of COV of IMEP for varying values of the pressure within the cylinder and the time. In other embodiments, the COV of IMEP may be determined by the controller 22 based on other parameters such as a combustion ignition delay, a combustion duration, and so on without limiting the scope of the disclosure.

The fuel control system 18 includes a second sensor 26 coupled to the engine 10. More specifically, the second sensor 26 is a Nitrous Oxide (NOx) sensor. The second sensor 26 is coupled to an exhaust manifold (not shown) or an exhaust stack (not shown) of the engine 10. The second sensor 26 is configured to generate a signal indicative of an amount of NOx present within an exhaust Etas of the engine 10. The second sensor 26 is further coupled to the controller 22 of the fuel control system 18.

The fuel control system 18 also includes a fuel reformer 28 coupled to the controller 22. The fuel reformer 28 is also fluidly coupled to a fuel delivery system (not shown) of the engine 10. The fuel delivery system may include a fuel tank, a fuel pump, a fuel rail, a fuel injector, a fuel line, and so on based on application requirements. The fuel delivery system is adapted to provide a supply of the fuel to the engine 10. Accordingly, the fuel reformer 28 is adapted to receive a portion of the fuel from the fuel delivery system.

The fuel reformer 28 is adapted to reform the fuel such as natural gas into Hydrogen (H2), Carbon Monoxide (CO), and/or other synthesized byproducts. The fuel reformer 28 is further fluidly coupled to the engine 10. Accordingly, the fuel reformer 28 is adapted to supply the reformed fuel to the engine 10. The fuel reformer 28 may be any reformer known in the art including, but not limited to, a catalyst type reformer, an auto thermal type reformer, a burner type reformer, and a steam type reformer based on application requirements.

The fuel control system 18 further includes an Air Fuel Ratio (AFR) unit 30 coupled to the controller 22. The AFR unit 30 is also fluidly coupled to the fuel delivery system and an air supply system (not shown) of the engine 10. The air supply system may include an air filter, a turbocharger, an intercooler, air inlet line, an inlet manifold, and so on based on application requirements. The air supply system is configured to supply air to the engine 10 for combustion purpose. Accordingly, the AFR unit 30 is adapted to receive a supply of the fuel from the fuel delivery system and a supply of air from the air supply system. The AFR unit 30 is further adapted to mix the air and the fuel received therein and control an air fuel ratio of the air fuel mixture supplied to the engine 10.

In one embodiment, based on the determined COV of IMEP, the controller 22 is configured to compare the COV of IMEP with a threshold combustion stability. A relatively lower value of the COV of IMEP is indicative of a stable combustion of the air fuel mixture within the cylinder. A relatively higher value of the COV of IMEP is indicative of an unstable combustion of the air fuel mixture within the cylinder.

Based on the comparison, the controller 22 is configured to regulate the fuel reformer 28 to control the combustion stability. More specifically, the fuel reformer 28 is regulated to vary an amount of reformed fuel and in turn the H2 present within the reformed fuel to be supplied to the engine 10. For example, when the controller 22 determines the combustion stability is lower than the threshold, the controller 22 regulates the fuel reformer 28 to increase the amount of reformed fuel to be supplied to the engine 10 in order to improve the combustion stability.

In one embodiment, the controller 22 may regulate the fuel reformer 28 based on a correlation stored in the database 24. The correlation may be a mathematical expression between the COV of IMEP, the threshold combustion stability, and the required amount of reformed fuel. In another embodiment, the controller 22 may regulate the fuel reformer 28 based on a dataset stored in the database 24. The dataset may include the required amount of reformed fuel for different values of the COV of IMEP and the threshold combustion stability.

In another embodiment, based on the signal indicative of the amount of NOx received from the second sensor 26, the controller 22 is configured to compare the amount of NOx with a threshold amount of NOx. Based on the comparison, the controller 22 is configured to regulate the AFR unit 30 to control the amount of NOx. More specifically, the AFR unit 30 is regulated to vary the air fuel ratio of the air fuel mixture and in turn a richness of the air fuel mixture to be supplied to the engine 10. For example, when the controller 22 determines the amount of NOx is higher than the threshold amount, the controller 22 regulates the AFR unit 30 to generate a lean air fuel mixture in order to reduce the amount of NOx below the threshold amount.

In one embodiment, the controller 22 may regulate the AFR unit 30 based on a correlation stored in the database 24. The correlation may be a mathematical expression between the amount of NOx, the threshold amount of NOx, and the required air fuel ratio. In another embodiment, the controller 22 may regulate the AFR unit 30 based on a dataset stored in the database 24. The dataset may include the required air fuel ratio for different values of the amount of NOx and the threshold amount of NOx.

In yet another embodiment, based on the determined COV of IMEP and the signal indicative of the amount of NOx received from the second sensor 26, the controller 22 is configured to simultaneously compare the COV of IMEP with the threshold combustion stability and the amount of NOx with the threshold amount of NOx.

Based on the comparison, the controller 22 is configured to simultaneously regulate the fuel reformer 28 to control the combustion stability and the AFR unit 30 to control the amount of NOx. For example, in one situation, when the controller 22 determines the amount of NOx is lower than the threshold amount and the combustion stability is below the threshold, the controller 22 regulates the AFR unit 30 to generate a rich air fuel mixture in order to improve the combustion stability while still maintaining the amount of NOx below the threshold amount.

In another situation, when the controller 22 determines the amount of NOx is approximately equal to the threshold amount and the combustion stability is below the threshold, the controller 22 regulates the fuel reformer 28 to increase the amount of reformed fuel to be supplied to the engine 10 in order to improve the combustion stability up to the threshold while still maintaining the amount of NOx approximately equal to the threshold amount.

In yet another situation, when the controller 22 determines the amount of NOx is higher than the threshold amount and the combustion stability is below the threshold, the controller 22 regulates the AFR unit 30 to generate a lean air fuel mixture in order to reduce the amount of NOx below the threshold amount. Also, the controller 22 regulates the fuel reformer 28 to increase the amount of reformed fuel to be supplied to the engine 10 in order to improve the combustion stability up to the threshold.

In one embodiment, the controller 22 may regulate the fuel reformer 28 and the AFR unit 30 based on a correlation stored in the database 24. The correlation may be a mathematical expression between the COV of IMEP, the threshold combustion stability, the required amount of reformed fuel, the amount of NOx, the threshold amount of NOx, and the required air fuel ratio. In another embodiment, the controller 22 may regulate the fuel reformer 28 and the AFR unit 30 based on a dataset stored in the database 24. The dataset may include the required amount of reformed fuel and the required air fuel ratio for different values of the COV of IMEP the threshold combustion stability, the amount of NOx and the threshold amount of NOx.

### INDUSTRIAL APPLICABILITY

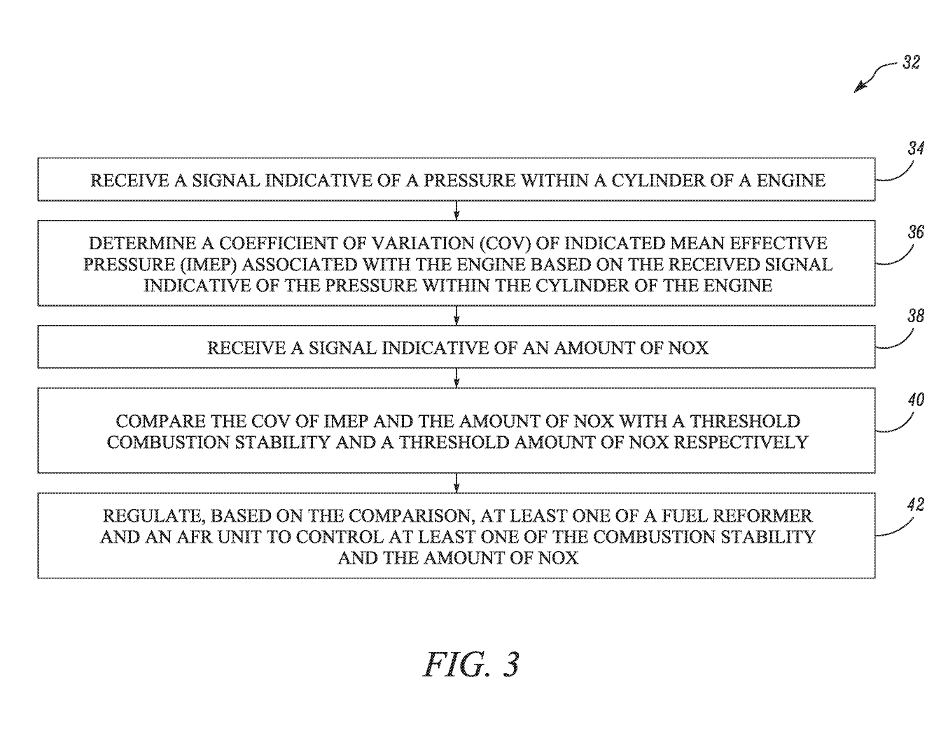

The present disclosure relates to the fuel control system 18 for controlling the combustion stability and the NOx emission for the engine 10 running on lean air fuel mixtures. Referring to FIG. 3, a method 32 of working of the fuel control system 18 is illustrated. At step 34, the controller 22 receives the signal indicative of the pressure within the cylinder of the engine 10 from the first sensor 20. At step 36, the controller 22 determines the COV of IMEP associated with the engine 10 based on the received signal indicative of the pressure within the cylinder of the engine 10. At step 38, the controller 22 receives the signal indicative of the amount of NOx from the second sensor 26. At step 40, the controller 22 compares the COV of IMEP and the amount of NOx with the threshold combustion stability and the threshold amount of NOx respectively. At step 42, based on the comparison, the controller 22 regulates at least one of the fuel reformer 28 and the AFR unit 30 to control at least one of the combustion stability and the amount of NOx.

In one situation, when the controller 22 determines the combustion stability is lower than the threshold, the controller 22 regulates the fuel reformer 28 to increase the amount of reformed fuel to be supplied to the engine 10 in order to improve the combustion stability. In another situation, when the controller 22 determines the amount of NOx is higher than the threshold amount, the controller 22 regulates the AFR unit 30 to generate the lean air fuel mixture to be supplied to the engine 10 in order to reduce the amount of NOx below the threshold amount. In vet another situation, when the controller 22 determines the combustion stability and/or the amount of NOx is away from the thresholds, the controller 22 simultaneously regulates the fuel reformer 28 and/or the AFR unit 30 to increase the amount of reformed fuel and reduce the amount of NOx respectively, as the case may be, in order to balance the combustion stability and the amount of NOx emission within the thresholds.

The fuel control system 18 provides an effective and cost efficient system for controlling the combustion stability and the NOx emission of the engine 10 while operating the engine 10 on lean air fuel mixtures without use of expensive components and/or complex control strategy. A higher combustion stability in turn leads to smoother operation of the engine 10, increased fuel efficiency, reduced noise, reduced vibration, increased engine life, and so on. Also, lower NOx emission from the engine 10 enables the engine to be emission complaint.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is clamed is:

1. A fuel control system for an engine, the fuel control system comprising:
a first sensor coupled to the engine, the first sensor configured to generate a signal indicative of a pressure within a cylinder of the engine;
a second sensor coupled to the engine, the second sensor configured to generate a signal indicative of an amount of Nitrous Oxide (NOx) present within an exhaust gas of the engine;
a fuel reformer coupled to the engine, the fuel reformer adapted to reform a portion of a fuel supplied to the engine into hydrogen (H2) and Carbon Monoxide (CO);
an Air Fuel Ratio (AFR) unit coupled to the engine, the AFR unit adapted to control an air fuel ratio of a mixture of air and the fuel supplied to the engine; and
a controller coupled to the first sensor, the second sensor, the fuel reformer, and the AFR unit, the controller configured to:
receive the signal indicative of the pressure within the cylinder of the engine;
determine a Coefficient of Variation (COV) of Indicated Mean Effective Pressure (IMEP) associated with the engine based on the received signal indicative of the pressure within the cylinder of the engine;
receive the signal indicative of the amount of NOx;
compare the COV of IMEP and the amount of NOx with a threshold combustion stability and a threshold amount of NOx respectively; and
regulate, based on the comparison, at least one of the fuel reformer and the AFR unit to control at least one of the combustion stability and the amount of NOx.
